(19) United States
(12) Patent Application Publication
(10) Pub. No.: US 2022/0003710 A1
(43) Pub. Date: Jan. 6, 2022

(54) SENSING DEVICE FOR MEASURING AN ELECTROCHEMICAL PARAMETER

(71) Applicant: The University of British Columbia, Vancouver (CA)

(72) Inventors: Edouard Asselin, Vancouver (CA); Hamed Akbari Khorami, Vancouver (CA)

(21) Appl. No.: 17/290,745

(22) PCT Filed: Nov. 1, 2019
(86) PCT No.: PCT/CA2019/051557

§ 371 Date: Apr. 30, 2021

Related U.S. Application Data
(60) Provisional application No. 62/754,475, filed on Nov. 1, 2018.

(51) Int. Cl. G01N 27/407; G01N 27/406; G01D 11/24; G01D 11/26

(52) U.S. Cl. CPC G01N 27/4078; G01D 11/26; G01D 11/245; G01N 27/4062

(57) ABSTRACT

The invention provides sensing devices for measuring an electrochemical parameter in a reactor. The sensing devices include one or more electrodes, a fastener comprising a female part and a male part, a compressible sealant inside an internal cavity of the male part, a spacer inside the internal cavity of the male part adjacent to and abutting the compressible sealant, a connector for connecting the compressible sealant and the male part and a connector for connecting the spacer and the compressible sealant. The male part, compressible sealant and spacer include one or more channels through which one of the one or more electrodes passes.

### FIELD

This invention relates to sensing devices for measuring an electrochemical parameter. In particular, the invention relates to sensing devices for real time and in situ measurements of the electrochemical parameter.

### BACKGROUND

The use of pressure hydrometallurgical reactors, whether they be for gold, copper or zinc, is becoming more common. For example, pressure oxidation (POX) is used to treat the increasing number of refractory gold ores that result in poor gold recovery when subjected to whole-ore direct cyanidation. Typically, these refractory ores comprise sulphides, such as pyrite and arsenopyrite, which encapsulate the submicron-sized gold and render it inaccessible to cyanide. The function of POX is to break down the sulphide, thus liberating the gold for downstream cyanidation. POX is typically operated at high oxygen partial pressures (150 to 700 kPa) and high temperature (approximately 200° C.) in an autoclave. The conditions prevalent in the POX reactor or autoclave are critical to the success of the downstream processing. In particular, it is very important that sulphide oxidation be controlled to ensure adequate break down of the sulphide minerals and high gold extraction during cyanidation. POX is usually controlled by parameters including particle size, pressure, temperature, density and pH of the slurry in the autoclave. All of these parameters together provide an oxidative condition, which is quantified by the oxidation/reduction potential (ORP) of the slurry. Thus, an in situ system for electrochemical measurement would be beneficial for process control of hydrometallurgical reactors.

The standard laboratory ORP probe works by measuring the potential difference between an inert platinum electrode and a reference electrode. The reference electrode is typically an Ag/AgCl or Hg/HgCl₂ reference couple. These reference electrodes are unstable at elevated temperatures and cannot be used over approximately 130° C. High temperature electrodes must exhibit a stable electrode potential at high temperatures and pressures, they must be chemically and thermodynamically stable, the electrode potential must be relatable to a reference standard and the materials of construction must be stable.

Four methods that may be used to obtain a reference potential at high temperature are an external pressure balanced reference electrode (EPBRE), a flow through reference electrode (FTRE), a yttria stabilized zirconia (YSZ) closed-end tube and a pseudo-reference electrode, all of which involve the measurement of voltage.

An EPBRE is an Ag/AgCl electrode that is located outside the pressure vessel and maintained at 25° C. They operate at system pressure but at a temperature that is safe for the reference. This provides a stable reference potential but must be carefully calibrated because of the ionic diffusion that occurs in the junction tube, due to temperature gradient, between the pressure vessel and the reference electrode. However, these electrodes are not robust. They must be refurbished often (cleaned and new solution put in), they typically employ one or two junction frits which can get clogged and the junction tube in the pressure vessel is prone to getting obscured by bubbles or by solids. These design issues limit the application of EPBRE in industrial settings.

A FTRE consists of chloridized silver wire mounted in a tube. Pressurized and dilute (typically about 0.01 M) NaCl or KCl solution is pumped through the tube and across the silver wire into the autoclave at a very slow rate (milliliters per minute). This results in an Ag/AgCl reference couple. The FTRE system removes the issue of ionic diffusion across a temperature gradient as the reference solution flow ensures a constant electrolyte composition in the bridge between the autoclave and the silver electrode. These electrodes are complex in that they require a high-pressure pump to feed the NaCl solution, the chloridized wire requires servicing and the bridge tube can be obscured or clogged by solids. This type of electrode has limited application in industrial settings due to the complexity of the apparatus.

A YSZ closed-end tube is filled with an internal junction of copper/cuprous oxide or nickel/nickel oxide solid mixture. These electrodes may be used as membrane-type pH sensors due to the direct relationship between the conduction of oxygen ions through the ceramic and the pH in the aqueous phase. They are only employed as a reference electrode when the pH of the system is known and constant.

Pseudo-reference electrodes consist of inert electrodes, such as gold, platinum or glassy carbon, whose potential is assumed to be invariant as a function of time. This assumption is not strictly correct but may be accurate under some conditions. For example, when there is a sufficient amount of hydrogen in the system, the pseudo-reference electrode may function as a standard hydrogen electrode. The advantage of a pseudo-reference electrode is that it is simple and robust. However, the potential of a pseudo-reference electrode is meaningless unless it is compared to a reference electrode through previous calibration on the basis that the measured potential changes as a function of solution ORP just the same as the potential on a working electrode would change as a function of ORP. Thus, measuring the potential between a pseudo-reference electrode and a working electrode is not sufficient to provide ORP since they are expected to exhibit proportionally varying potentials as a function of solution potential and no potential difference would be generated by increasing solution potential.

Thus, there remains a need for a sensing device for measuring an electrochemical parameter in situ at high temperatures and/or pressures.

### SUMMARY

In one aspect, the present disclosure provides a sensing device for measuring an electrochemical parameter, the device comprises one or more electrodes; a fastener comprising a female part and a male part, the male part comprising an internal cavity defining first and second sealing surfaces, the first sealing surface vertically off-set from the second sealing surface, the second sealing surface comprising one or more channels through which one of the one or more electrodes passes; a sealant located in the internal cavity of the male part, the sealant comprising one or more channels which overlap with the one or more channels of the male part and through which one of the one or more electrodes passes, a top surface, and first and second sealing surfaces opposite the top surface adjacent to and abutting the first and second sealing surfaces of the male part, respectively; a spacer located in the internal cavity of the male part adjacent to and abutting the top surface of the sealant, the spacer comprising a top surface, a bottom surface and one or more channels that overlap with the one or more channels of the sealant and through which one of the one or more electrodes passes; and connecting means for connecting the spacer and the sealant.

Various aspects of the present disclosure also provide a system for measuring an electrochemical parameter, the system comprising one or more electrodes for taking an electrochemical measurement; a fastener comprising a female part and a male part for holding the one or more electrodes, the male part comprising an internal cavity defining first and second sealing surfaces, the first sealing surface vertically off-set from the second sealing surface and the second sealing surface comprising one or more channels through which one of the one or more electrodes passes; a sealant in the internal cavity of the male part for sealing the one or more electrodes, the sealant comprising one or more channels which overlap with the one or more channels of the male part and through which one of the one or more electrodes passes, a top surface, and first and second sealing surfaces opposite the top surface which correspond to and abut the first and second sealing surfaces of the male part, respectively; a spacer located in the internal cavity of the male part adjacent to and abutting the top surface of the sealant for applying a force to the sealant when the female and male parts are fastened together, the spacer comprising a top surface, a bottom surface and one or more channels which overlap with the one or more channels of the sealant and through which one of the one or more electrodes passes; and connecting means for connecting the spacer and the sealant for preventing rotation of the spacer relative to the sealant when the female and male parts are fastened together.

In various embodiments, the system may also comprise connecting means for connecting the sealant and the male part for preventing rotation of the sealant relative to the male part when the female and male parts are fastened together.

Various aspects of the present disclosure also provide a method of sealing a sensing device, the method comprising inserting a sealant into an internal cavity of a male part of a fastener, the male part comprising first and second sealing surfaces wherein the first sealing surface is vertically off-set from the second sealing surface and the second sealing surface comprises one or more channels, the sealant comprising first and second sealing surfaces adjacent to and abutting the first and second sealing surfaces of the male part, respectively, and one or more channels overlapping with the one or more channels of the male part; inserting a spacer into the internal cavity of the male part of the fastener adjacent to and abutting the sealant and connecting the spacer to the sealant, the spacer comprising one or more channels overlapping with the one or more channels of the sealant; inserting one or more electrodes through the one or more overlapping channels of the spacer, the sealant and the male part of the fastener; and fastening a female part to the male part of the fastener. The methods may further comprise connecting the sealant to the male part of the fastener.

In various embodiments, the sealant may be a compressible sealant. The compressible sealant in the internal cavity of the male part may expand under reaction conditions in the reactor, thereby sealing the one or more electrodes. In alternative embodiments, the sealant may be an incompressible sealant. The incompressible sealant may be permanently sealed against the electrodes, and the first and second sealing surfaces of the male part.

Various aspects of the present invention further provide use of a sensing device as described herein for measuring an electrochemical parameter of a redox couple.

Other aspects and features of the present invention will become apparent to those of ordinary skill in the art upon review of the following description of specific embodiments of the invention in conjunction with the accompanying claims.

### BRIEF DESCRIPTION OF THE DRAWINGS

In drawings which illustrate embodiments of the disclosure,

FIG. 1 shows a plane view of a sensing device according to an embodiment as disclosed herein.

FIG. 2 shows a male part of a fastener according to an embodiment of the sensing device as disclosed herein in (A) a plane view; (B) a side view; (C) a top view; and (D) a bottom view.

FIG. 3 shows a sealant according to an embodiment of the sensing device as disclosed herein in (A) a plane view; (B) a side view; (C) a top view; and (D) a bottom view.

FIG. 4 shows a spacer according to an embodiment of the sensing device as disclosed herein in (A) a side view; and (B) a bottom view.

FIG. 5 shows a female part of the fastener according to an embodiment of the sensing device as disclosed herein in (A) a side view; and (B) a plane view.

FIG. 6 shows a sealant according to an additional embodiment of the sensing device as disclosed herein having a first sealing surface that is oblique to an applied force in (A) a plane view; and (B) a side view.

FIG. 7 shows a side view of a male part of the fastener according to an additional embodiment of the sensing device as disclosed herein and having a first sealing surface that is oblique to an applied force.

FIG. 8 shows a schematic diagram of a reactor set-up using a sensing device according to an embodiment of the disclosure.

### DETAILED DESCRIPTION

In the context of the present disclosure, various terms are used in accordance with what is understood to be the ordinary meaning of those terms.

In various embodiments, the disclosure provides sensing devices for electrochemical measurements. The measurements may be taken in situ. The measurements may be taken inside a reactor such as a batch or continuous reactor, for example, an autoclave. In various embodiments, the sensing devices disclosed herein comprise one or more electrodes, a fastener comprising a female part and a male part, a sealant, a spacer, and connecting means for connecting the spacer and the sealant. The sensing devices may also include connecting means for connecting the male part and the sealant.

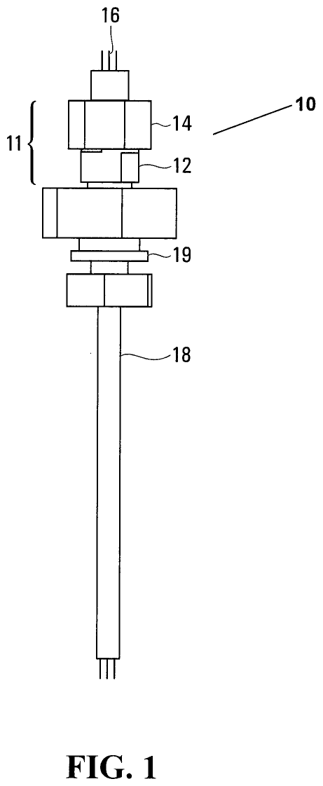

FIG. 1 shows a sensing device 10 according to an embodiment of the disclosure. The sensing device 10 comprises a fastener 11 including a male part 12 and a female part 14. In various embodiments the fastener 11 comprises threaded male and female parts 12 and 14, respectively. In various embodiments, the fastener comprises a corrosion resistant material. The corrosion resistant material may be any suitable alloy such as, for example, a nickel-based alloy. In various embodiments, the fastener is stainless-steel, titanium or a titanium alloy.

The sensing device 10 also comprises one or more electrodes 16. In various embodiments, the sensing device 10 may comprise two electrodes. In other embodiments, the sensing device 10 may comprise three electrodes, as shown in FIG. 1. The one or more electrodes 16 may be any suitable conductive or semi-conductive material which resists corrosion in the environment of the reactor. For example, the one or more electrodes 16 may independently be a ruthenium, rhodium, palladium, osmium, gold, carbon, palladium, rhenium, silver, or iridium electrode, an alloy thereof or a material coated with one of the foregoing (such as, for example, platinized titanium). In various embodiments, the one or more electrodes 16 are platinum electrodes. The sensing device 10 may also comprise a housing 18 for containing the one or more electrodes 16 in a reactor and a fitting 19 for connecting the housing 18 to the male part 12 for insertion into a reactor, such as an autoclave. For example, the fitting 19 may be a straight union fitting.

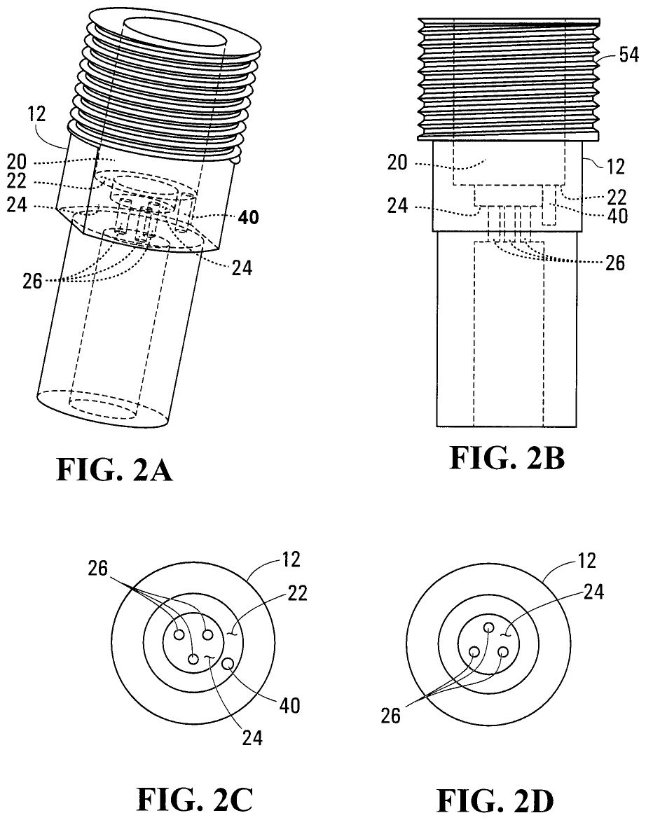

FIG. 2 shows the male part 12 of the fastener 11. As shown in FIG. 2A, the male part 12 comprises an internal cavity 20 that defines first and second sealing surfaces, 22 and 24, respectively, the first sealing surface 22 being vertically off-set from the second sealing surface 24. The second sealing surface 24 comprises one or more channels 26 through which one of the one or more electrodes 16 passes. FIG. 2B shows a side view of the male part 12 with first sealing surface 22, second sealing surface 24 and one or more channels 26. The embodiment shown in FIG. 2 includes three channels 26. FIG. 2C shows a top view of male part 12 and FIG. 2D shows a bottom view of male part 12.

A sealant 28 is located in the internal cavity 20 of the male part 12. In various embodiments, the sealant 28 may be compressible or incompressible. In the context of the present disclosure, the term “compressible” means that a volume of a material significantly changes when pressure is applied to it. In various embodiments, the sealant 28 may be permanently attached to or engaged with the male part 12 or alternatively, the sealant 28 is a separate component that can be taken out of the male part 12 and then the sensing device reassembled. In various embodiments, the sealant 28 is compressible and a separate component from the male part 12.

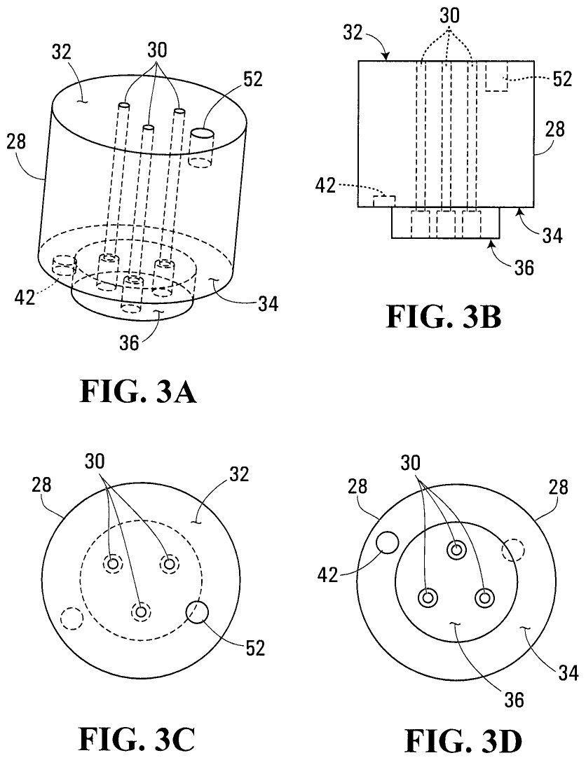

A compressible sealant 28 according to an embodiment of the invention is shown in FIG. 3. As shown in FIG. 3A, the sealant 28 comprises one or more channels 30 which overlap with the one or more channels 26 of the male part 12 and through which one of the one or more electrodes 16 passes. The sealant 28 also comprises a top surface 32, and first and second sealing surfaces 34 and 36, respectively, opposite the top surface 32 adjacent to and abutting the first and second sealing surfaces 22 and 24, respectively, of the male part 12. The one or more channels 30 pass through the second sealing surface 36. A side view of sealant 28 is shown in FIG. 3B, a top view of the sealant 28 is shown in FIG. 3C and a bottom view of the sealant 28 is shown in FIG. 3D. In various embodiments, the compressible sealant is a high temperature resistant polymer and/or a polymer-ceramic composite material. In various embodiments, the compressible sealant may comprise polybenzimidazole (PBI), polyimide-imide, polyether ether ketone (PEEK), polytetrafluoroethylene (PTFE), polyimide (PI), or a combination thereof.

As an incompressible sealant, the incompressible sealant comprises one or more channels 30 which overlap with the one or more channels 26 of the male part 12 and through which one of the one or more electrodes 16 passes. The incompressible sealant 28 also comprises a top surface 32 and first and second sealing surfaces 34 and 36, respectively, opposite the top surface 32 and which may be permanently attached to or engaged with the first and second sealing surfaces 22 and 24, respectively, of the male part 12. The one or more channels 30 pass through the second sealing surface 36. An incompressible sealant may be fabricated to the requisite dimensions for the internal cavity of the male part and for sealing against the one or more electrodes and the first and second sealing surfaces of the male part. In various embodiments, the incompressible sealant may comprise glass or a ceramic, such as a machinable ceramic.

The first and second sealing surfaces 22 and 24, respectively, of the male part 12 and the first and second sealing surfaces 34 and 36, respectively, of the sealant 28 may increase the durability of the sensing device 10 and reduce the failure risk related to sealing surface damage. The second sealing surface in particular is exposed to very corrosive and harsh conditions inside the reactor and damage to the sealing surface is inevitable. The first sealing surface ensures that damage to the sensing device 10 is minimized by minimizing the exposure of the sealant to the harsh environment inside the reactor, such as in a hydrometallurgical autoclave.

Sensing device 10 may also comprises connecting means for connecting the sealant 28 and the male part 12. In various embodiments, the connecting means may comprise a first receptacle 40 on the first sealing surface 22 of the male part 12, as shown in FIGS. 2A, 2B and 2C, a second receptacle 42 on the first sealing surface 34 of the sealant 28 and overlapping with the first receptacle 40, as shown in FIGS. 3A, 3B and 3C, and a rod (not shown) operably configured to be received in both the first and second receptacles 40 and 42, respectively. The connecting means prevent the male part 12 and the sealant 28 from moving relative to each other when the male part 12 and the female part 14 are fastened together. The connecting means may also comprise any suitable adhesive as would be known to a person of ordinary skill in the art.

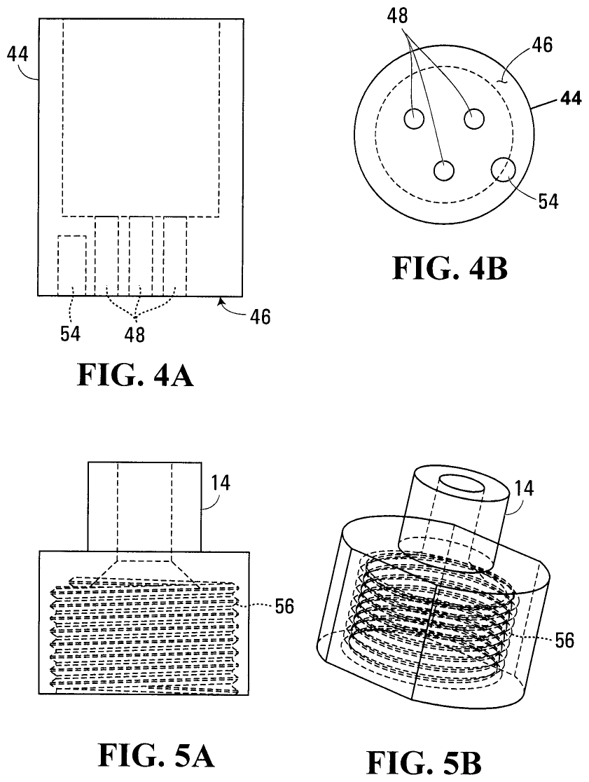

The sensing device 10 comprises a spacer 44 located in the internal cavity 20 of the male part 12. A side view of a spacer 44 according to an embodiment of the invention is shown in FIG. 4A. A bottom view of the spacer 44 is shown in FIG. 4B. The spacer 44 is adjacent to and abutting the top surface 32 of the sealant 28. The spacer 44 comprises a top surface, a bottom surface 46 and one or more channels 48 that overlap with the one or more channels 30 of the sealant 28 and through which one of the one or more electrodes 16 passes. In various embodiments, the spacer 44 comprises a corrosion resistant material. The corrosion resistant material may be any suitable alloy such as, for example, a nickel-based alloy. In various embodiments, the spacer 44 is stainless-steel, titanium or a titanium alloy.

Sensing device 10 also comprises connecting means for connecting the spacer 44 and the sealant 28. In various embodiments, the connecting means may comprise a first receptacle 52 on the top surface 32 of the sealant 28, as shown in FIGS. 3A, 3B and 3D, a second receptacle 54 on the bottom surface 46 of the spacer 44 and overlapping with the first receptacle 52, as shown in FIGS. 4A and 4B, and a rod (not shown) operably configured to be received in both the first and second receptacles. The connecting means prevent the spacer 44 and the sealant 28 from moving relative to each other and to the male part 12 when the male part 12 and the female part 14 are fastened together. If the spacer 44 and the sealant 28 move when the male part 12 and the female part 14 are fastened together, the one or more electrodes 16 may be damaged by even small rotation of the sealant 28 and the spacer 44 relative to the male 12 and female 14 parts when the fastener 11 is tightened. The connecting means may also comprise any suitable adhesive as would be known to a person of ordinary skill in the art.

To assemble the sensing device 10, the sealant 28 is inserted into the internal cavity 20 of the male part 12 followed by the spacer 44. If the connecting means comprise the rod and receptacle assembly described above, the rod is inserted into the first receptacle 40 of the male part 12 and the second receptacle 42 of the sealant 28 is placed on top of the metal rod. A second rod is then placed in the first receptacle 52 on the top surface 32 of the sealant 28 and the second receptacle 54 of the spacer 44 is placed on top of this rod. The one or more electrodes 16 are then passed through the one or more channels of the spacer 44, the sealant 28 and the male part 12 (48, 30 and 26, respectively). Alternatively, the connecting means may be an adhesive. In a further embodiment, the sealant 28 may be placed as a powder, liquid, gel or slurry into the internal cavity 20 of the male part 12 and around the one or more electrodes 16 that have been put into place in the male part 12. The assembly may then be thermally treated, sintered, or reacted with a catalyst or other reagent in order to set the powder, liquid or gel to form the sealant 28. In these embodiments, the sealant 28 is substantially incompressible and permanently attached to or engaged with the male part 12.

The female part 14 is fastened to the male part 12 containing the sealant and the spacer. FIG. 5A shows a side view of the female part 14 according to an embodiment of the invention and FIG. 5B shows a plane view. In various embodiments and as shown in FIGS. 2A, 2B, 5A and 5B, the male and female parts comprise threaded portions 54 and 56, respectively, that are twisted together to seal the fastener 11.

In various embodiments, fastening the male and female parts 12 and 14, respectively, may exert a force or compressive stress on the spacer 44 which in turn exerts a force on the sealant 28. A combined length of the sealant 28 and the spacer 44 along a vertical axis may be longer than a length of the internal cavity 20 of the male part 12 on the vertical axis when the female and male parts 12 and 14, respectively, are not fastened. Compressing the sealant 28 may cause the sealant 28 to exert a force against walls of the internal cavity 20 of the male part 12 and on the first and second sealing surfaces 22 and 24, respectively, of the male part 12 which keeps the components of the sensing device 10 sealed even at high temperatures and pressures of an operating autoclave. In various embodiments, there may be no gaps between components of the sensing device 10. However, in some embodiments, gaps may remain between the one or more channels 30 of the sealant 28 and the one or more electrodes 16. These gaps may be eliminated due to thermal expansion of the sealant 28 when the sensing device 10 is installed in a reactor or autoclave and an operating temperature of the autoclave increases, resulting in an increase in temperature of the sensing device components, including the sealant 28.

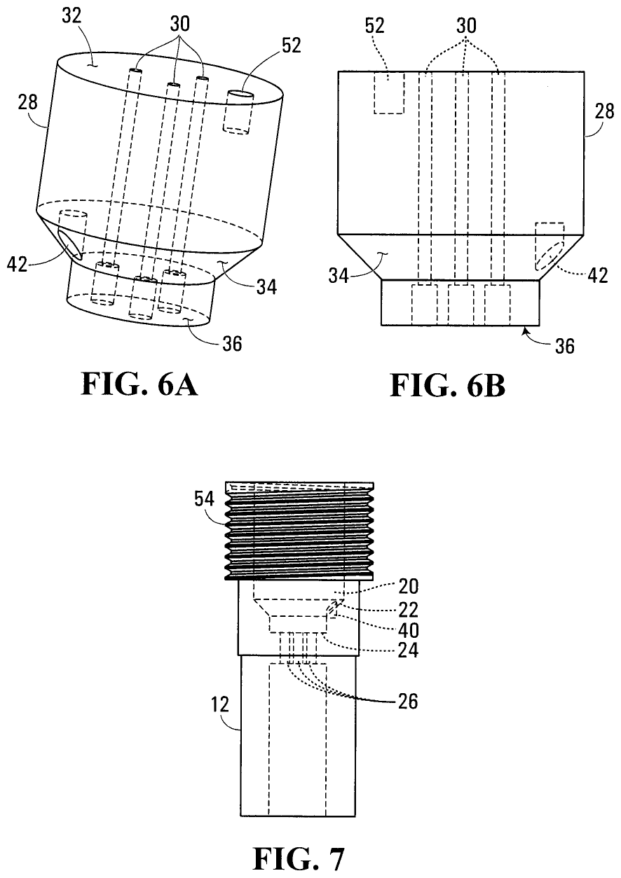

The first and second sealing surfaces 22 and 24, respectively, of the male part 12 and the first and second sealing surfaces 34 and 36, respectively, of the sealant 28 may be perpendicular to the applied force when the male and female parts 12 and 14, respectively, are fastened together. Alternatively, these surfaces may be oblique to the applied force when the male and female parts 12 and 14, respectively, are fastened together. FIG. 6 shows the sealant 28 (FIG. 6A) having a first sealing surface 34 that is oblique to the applied force. FIG. 7 shows a corresponding male part 12 with the first sealing surface 22 oblique to the applied force.

Having first and second sealing surfaces for the sealant 28 and the male part 12 also minimizes the space available for expansion of the sealant 28 under compression and at high temperatures, creating more force or compressive stress on the walls and sealing surfaces of the male part 12 and increasing transversal expansion of the sealant 28. This increased transversal expansion may result in better sealing between the sealant 28 and the one or more electrodes 16.

In various embodiments, the one or more electrodes 16 are sealed inside the sensing device 10 in a way that the device stays sealed at high temperatures and pressures inside batch or continuous systems or reactors. For example, the sensing devices disclosed herein may be installed in autoclaves in which hydrometallurgical processes take place at high temperatures and pressures. By installing the sensing device inside an autoclave, in situ and real time measurements of electrochemical parameters can be measured. By conducting measurements inside the reactor in situ and in real time, processes inside the reactor can be more precisely controlled and optimized by changing the operating conditions and parameters in response to the in situ and real time measurements. For example, the oxidation-reduction potential or pH of a slurry for a hydrometallurgical process can be measured. In various embodiments, potential or current inside the reactor may be measured as the electrochemical parameter.

In various embodiments, the sensing device 10 may collect and transfer electrochemical signals from inside a batch or continuous reactor to an electrochemical measurement instrument such as a potentiostat or galvanostat. In various embodiments, the sensing device 10 may be used in galvanostatic polarization, potentiostatic polarization, potentiodynamic polarization, cyclic voltammetry, linear scan voltammetry, impedance spectroscopy, open circuit potential measurement and electrochemical noise measurements. In various embodiments, the measurements are made in real time and in situ from within the batch or continuous reactor.

The sensing device 10 may used for measuring an electrochemical parameter of a redox couple. The electrochemical parameter may be an electrochemical rate parameter. In various embodiments, the electrochemical rate parameter may be current, impedance, polarization resistance, charge transfer resistance or electrochemical noise. For example, a kinetic parameter of a redox couple at an electrode surface may be measured, as described, for example, in WO2018/201251. In redox processes, a reducing agent (or reductant) transfers electrons to an oxidizing agent (or oxidant), and during a redox reaction, the reducing agent loses electrons and becomes oxidized, while the oxidizing agent gains electrons and is reduced. The oxidizing agent and the reducing agent for a particular reaction form a redox couple. The redox couple is a reducing species and its corresponding oxidizing form. Thus, the redox couple may comprise a species in a lower oxidation (or valent) state and another species in a higher oxidation (or valent) state. The species may be metal or metalloid species, or may be metal oxide species. In various embodiments, the redox couple may be ionic, or alternatively, one or both species of the redox couple are in a solid state. In various embodiments, the redox couple is ionic, soluble in solution and stable under the operating conditions of a reactor. Examples of redox couples include, but are not limited to, Fe²⁺/Fe³⁺, Cu⁺/Cu²⁺, As³⁺/As⁵⁺, Sb³⁺/Sb⁵⁺, Ag/Ag⁺, Mn²⁺/Mn⁴⁺, Mn⁴⁺/Mn⁷⁺, Au/Au⁺, Au/Au³⁺, and Pb/Pb²⁺.

In various embodiments, the sensing device may be for use in batch or continuous reactors including autoclaves with high operating temperatures and pressures such as, for example, up to 300° C. and 5000 kPa as well as highly acidic environments such as, for example, 0.153 M sulfuric acid, pH of 0.82.

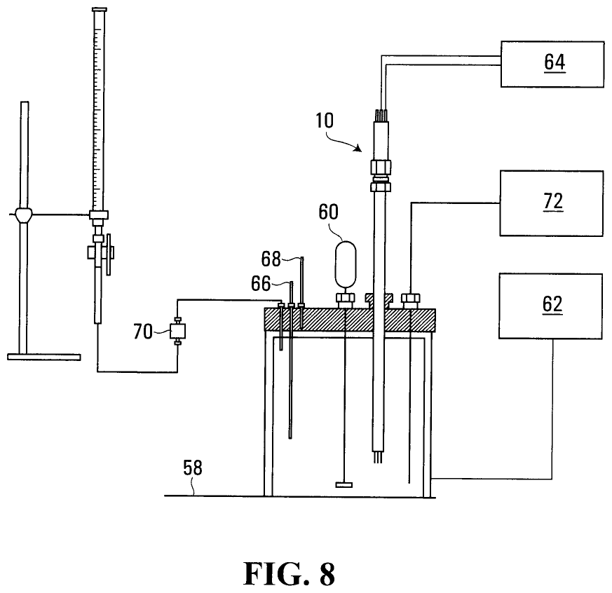

FIG. 8 shows a detailed schematic of an autoclave using the sensing device 10 according to an embodiment of the invention. A high temperature high-pressure autoclave (Inconel 625) with a glass liner 58 was equipped with a stirrer 60. The cell solution was heated and kept at a constant temperature with a controller 62. The sensing device 10 disclosed herein was placed in the cell and electrochemical measurements were obtained using a potentiostat 64. A gas inlet 66 and outlet 68 may be used for applying an oxygen over-pressure. The cell solution comprised 0.153 M H₂SO₄ (pH=0.82). The operating temperature was 260° C., and the system was pressurized to 5000 kPa. A high precision positive displacement dual piston metering pump (Eldex ReciPro metering pump 70, model 1481, BB-4-VS)) may be used to add various solutions to the autoclave. The autoclave may also include a reference electrode 72. During testing, no leakage of the cell solution into the sensing device was observed.

Although various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way. Numeric ranges are inclusive of the numbers defining the range. The word “comprising” is used herein as an open-ended term, substantially equivalent to the phrase “including, but not limited to”, and the word “comprises” has a corresponding meaning. As used herein, the singular forms “a”, “an” and “the” include plural referents unless the context clearly dictates otherwise. Thus, for example, reference to “a thing” includes more than one such thing. Citation of references herein is not an admission that such references are prior art to the present invention. Any priority document(s) and all publications, including but not limited to patents and patent applications, cited in this specification are incorporated herein by reference as if each individual publication were specifically and individually indicated to be incorporated by reference herein and as though fully set forth herein. The invention includes all embodiments and variations substantially as hereinbefore described and with reference to the examples and drawings.

1. A sensing device for measuring an electrochemical parameter, the device comprising:
one or more electrodes;
a fastener comprising a female part and a male part, the male part comprising an internal cavity defining first and second sealing surfaces, the first sealing surface vertically off-set from the second sealing surface, the second sealing surface comprising one or more channels through which one of the one or more electrodes passes;
a sealant located in the internal cavity of the male part, the sealant comprising one or more channels which overlap with the one or more channels of the male part and through which one of the one or more electrodes passes, a top surface, and first and second sealing surfaces opposite the top surface adjacent to and abutting the first and second sealing surfaces of the male part, respectively;
a spacer located in the internal cavity of the male part adjacent to and abutting the top surface of the sealant, the spacer comprising a bottom surface and one or more channels that overlap with the one or more channels of the sealant and through which one of the one or more electrodes passes; and
a connector configured for connecting the spacer and the sealant.

2. The sensing device of claim 1, further comprising a housing containing the one or more electrodes.

3. The sensing device of claim 1, further comprising a fitting connecting the housing to the male part of the fastener.

4. The sensing device of claim 3, wherein the fitting is a union fitting.

5. The sensing device of claim 1, wherein the sensing device comprises three electrodes, and each of the male part, the sealant and the spacer comprise three channels through which each of the electrodes passes.

6. The sensing device of claim 1, wherein the sealant is incompressible.

7. The sensing device of claim 1, wherein the sealant is compressible.

8. The sensing device of claim 7, wherein a length of the sealant and the spacer along a vertical axis is longer than a length of the internal cavity of the male part on the vertical axis when the female and male parts are not fastened.

9. (canceled)

10. The sensing device of claim 1, further comprising a second connector configured for connecting the male part and the sealant.

11. The sensing device of claim 10, wherein the male part comprises a first receptacle on the first sealing surface, the sealant comprises a second receptacle on the first sealing surface overlapping with the first receptacle, and the second connector comprises a rod operably configured to be received in both the first and second receptacles.

12. The sensing device of claim 1, wherein the sealant comprises a first receptacle on the top surface, the spacer comprises a second receptacle on the bottom surface overlapping with the first receptacle, and the connector comprises a rod operably configured to be received in both the first and second receptacles.

13. (canceled)

14. (canceled)

15. (canceled)

16. A system for measuring an electrochemical parameter, the system comprising:
one or more electrodes for taking an electrochemical measurement;
a fastener comprising a female part and a male part for holding the one or more electrodes, the male part comprising an internal cavity defining first and second sealing surfaces, the first sealing surface vertically off-set from the second sealing surface and the second sealing surface comprising one or more channels through which one of the one or more electrodes passes;
a sealant in the internal cavity of the male part for sealing the one or more electrodes, the sealant comprising one or more channels which overlap with the one or more channels of the male part and through which one of the one or more electrodes passes, a top surface, and first and second sealing surfaces opposite the top surface which correspond to and abut the first and second sealing surfaces of the male part, respectively,
a spacer located in the internal cavity of the male part adjacent to and abutting the top surface of the sealant for applying a force to the sealant when the female and male parts are fastened together, the spacer comprising a bottom surface and one or more channels which overlap with the one or more channels of the sealant and through which one of the one or more electrodes passes; and
a connector configured for connecting the spacer and the sealant for preventing rotation of the spacer relative to the sealant when the female and male parts are fastened together.

17. The system of claim 16, further comprising a housing for containing the one or more electrodes.

18. (canceled)

19. (canceled)

20. (canceled)

21. The system of claim 16, wherein the sealant is incompressible.

22. The system of claim 16, wherein the sealant is compressible.

23. The system of claim 22, wherein a length of the sealant and the spacer along a vertical axis is longer than a length of the internal cavity of the male part on the vertical axis when the female and male parts are not fastened.

24. (canceled)

25. The system of claim 22, wherein the sealant expands under reaction conditions in a reactor.

26. The system of claim 16, further comprising a second connector configured for connecting the male part and the sealant for preventing rotation of the sealant relative to the male part when the female and male parts are fastened together.

27. The system of claim 26, wherein the male part comprises a first receptacle on the first sealing surface, the sealant comprises a second receptacle on the first sealing surface overlapping with the first receptacle, and the second connector comprises a rod operably configured to be received in both the first and second receptacles.

28. The system of claim 16, wherein the sealant comprises a first receptacle on the top surface, the spacer comprises a second receptacle on the bottom surface overlapping with the first receptacle, and the connector comprises a rod operably configured to be received in both the first and second receptacles.

29.-40. (canceled)
